(19) United States
(12) Patent Application Publication
(10) Pub. No.: US 2010/0100366 A1
(43) Pub. Date: Apr. 22, 2010

(54) MICRORNA DETECTING APPARATUS, METHOD, AND PROGRAM

(75) Inventors: Goro Terai, Tokyo (JP); Toutai Mitsuyama, Tokyo (JP)

Correspondence Address: PEARNE & GORDON LLP, 1801 EAST 9TH STREET, SUITE 1200, CLEVELAND, OH, 44114-3108, US

(73) Assignees: INTEC SYSTEMS INSTITUTE, INC., Tokyo (JP); National Institute of advanced Industrial Science and Technology, Tokyo (JP)

(21) Appl. No.: 12/254,637

(22) Filed: Oct. 20, 2008

(51) Int. Cl. G06G 7/60

(52) U.S. Cl. 703/11

(57) ABSTRACT

A microRNA detecting apparatus finds a region matching a microRNA model from a base sequence using base vector sequence data generated from inputted base sequence information of a detection processing target and a microRNA model that is a probability model of known microRNA. The base vector sequence data is a sequence of base vectors corresponding to respective bases of the base sequence. Each of the base vectors includes a parameter of a degree of evolutional conservation that is a characteristic of microRNA and parameters of a secondary structure that characterize a stable hairpin structure. Concerning the secondary structure, the base vector includes a stem parameter and a loop parameter in addition to a parameter of minimum free energy. The Hidden Markov Model is used as the microRNA model. It is possible to improve the accuracy of detection of the microRNA region on the base sequence when the base sequence information is processed by the bioinformatics technique.

### BACKGROUND OF THE INVENTION

1. Field of the Invention

The present invention relates to a microRNA detecting apparatus, and more particularly, to an apparatus that analyzes nucleotide base (hereinafter, base) sequence information such as a genome using bioinformatics technology, and detects a microRNA region.

2. Background

MicroRNA (hereinafter, miRNA) is the most well-characterized family of non-coding RNA. MiRNAs can regulate gene expression through binding to 3′UTR of messenger RNA (hereinafter mRNA) and by causing translational inhibition or mRNA degradation Several hundreds of miRNAs have so far been found in the human genome Recent computational analyses suggest that as many as several thousands of human genes are regulated by miRNAs. Several studies have shown the importance of miRNAs in cell differentiation and development in mammals. Many miRNAs are located at chromosomal fragile sites involved in cancers, and differentially regulated in cancer cells. This suggests a relationship between miRNAs and cancer. Therefore, finding the novel miRNAs has significant biological and clinical impacts.

A miRNA gene is transcribed as a long RNA molecule called a pri-miRNA. The pri-miRNA is then processed to about 70 to 100 bp hairpin structures called pre-miRNA. Finally, a mature miRNA of 19 to 23 bp is extracted from the pre-miRNA by an enzyme called a Dicer. In the following explanation in this specification, a pre-miRNA is simply denoted as a “miRNA (microRNA)”.

MiRNAs tend to form a stable hairpin structure and most miRNAs are highly conserved among vertebrates. Therefore, several computational methods for detecting miRNA have been developed that exploit secondary structural stability and evolutional conservation.

As a related art, a pipeline that combines homology search and secondary structure prediction step by step is proposed. At a first step, conserved hairpin structures are identified from intergenic regions. Then, at a second step, hairpin structures with mutation patterns typical to miRNAs are selected out of the hairpin structures. Alternatively, at the second step, hairpin structures having miRNA specific features are identified. The specific features are symmetric bulges, a highly conserved stem near a hairpin loop, and the like.

A method that takes into account the conservation pattern of not only miRNA but also surrounding regions thereof has also been developed. In the method, highly-homologous intergenic regions are first detected. Then, regions that have conservation patterns typical to miRNA and can form stable hairpin structures are extracted out of the intergenic regions.

Recently, new miRNA candidates are published using a database. In the database, among non-coding RNAs predicted by using a program, non-coding RNAs that can form stable hairpin structures are considered as miRNA candidates. A support vector machine (SVM) based method that incorporates several types of secondary structural and conservation features of multiple sequence alignment is also reported.

There are other types of methods for predicting miRNAs. Similarity based approaches have been proposed, in which sequence and structural similarities to known miRNAs are assessed. A target-sequence-driven approach has been reported, in which hairpin structures having a sequence segment that are overrepresented in conserved 3′UTR regions are considered to be miRNA candidates. Methods that do not rely on sequence conservation have also been proposed, in which detailed structural and sequence features are used as features of machine learning algorithms. The structural and sequence features are a nucleotide frequency, the length of predicted stem, the size of symmetric loops, and the like.

A technique for detecting miRNAs in the past is disclosed in, for example, Lim, L. P. et al. “The microRNAs of Caenorhabditis elegans,” “GENES & DEVELOPMENT.” Cold Spring Harbor Laboratory Press, Apr. 2, 2003, vol. 17, pp 991 to 1008, www.genesdev.org.

As described above, several techniques for detecting microRNAs have been proposed. While microRNAs attract attention, there is a demand for further provision of techniques that can highly accurately detect microRNAs. In particular, there is a demand for a microRNA detection technique that can withstand practical applications such as comprehensive detection of new microRNAs from a human genome sequence.

### SUMMARY OF THE INVENTION

The present invention has been made in view of the above described situation and it is an object of the present invention to provide a microRNA detecting apparatus that can improve the accuracy of detection of microRNAs.

According to an aspect of the present invention, there is provided a microRNA detecting apparatus that detects a microRNA region from base sequence information, the microRNA detecting apparatus including: an input unit that inputs base sequence information of a detection processing target; a base-vector-sequence generating unit that generates, from the base sequence information of the detection processing target, data of a sequence of base vectors (hereinafter, base vector sequence) formed by a plurality of base vectors respectively corresponding to a plurality of bases included in a sequence, each of the base vectors including a plurality of kinds or types of parameters that characterize microRNA; a microRNA-model storing unit that stores a microRNA model that is generated from a known microRNA group, the microRNA model being a probability model of a base vector sequence group including a plurality of the base vector sequence data respectively corresponding to a plurality of known microRNAs in the known microRNA group; and a microRNA detecting unit that detects, based on the base vector sequence data generated by the base-vector-sequence generating unit and the microRNA model of the microRNA-model storing unit, a region matching the microRNA model from the base sequence of the detection processing target as a microRNA region, wherein the plurality of kinds of parameters of each of the base vectors forming the base vector sequence data include a conservation score parameter representing a degree of evolutional conservation in a relevant base of each of the base vectors and secondary structural parameters characterizing a stable hairpin structure, and the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.

The stem parameter and the loop parameter may represent a level of probability that each relevant base is present in the stem section and the loop section, respectively.

As described above, in the present invention, the base vector sequence data generated from the base sequence information of the detection processing target and the microRNA model that is the probability model of the known microRNAs are used. In the present invention, a microRNA region can be detected by detecting a region matching the microRNA model from the base sequence. In the present invention, each of the base vectors forming the base vector sequence data includes the parameter of a degree of evolutional conservation and the parameter of the stable hairpin structure, which are characteristics of microRNA. In particular, concerning the stable hairpin structure, each of the base vectors includes, in addition to the parameter of minimum free energy, the parameters representing possibilities that each of bases corresponds to a stem and a loop based on a base pair probability as described above. The accuracy or performance of detection of microRNAs can be improved by adopting such vector representation.

The microRNA model may be a Hidden Markov Model, and the microRNA detecting unit may perform variable-length microRNA region detection using the Hidden Markov Model.

The microRNA model may be generated from a group of known microRNAs with unfixed sequence length.

The Hidden Markov Model of the microRNA model may be a state transition model in which respective states correspond to respective bases of a base sequence, and the number of states through which a state transition path can pass may be limited to a predetermined range.

The Hidden Markov Model of the microRNA model may be a state transition model in which respective states correspond to respective bases of a base sequence, and state transition probabilities of respective sections of the model may be set such that a product of state transition probabilities along a state transition path is the same regardless of the state transition path.

The loop parameter may Include a base pair probability total, which is a total of base pair probabilities corresponding to base pairs sequentially located on outer sides with respect to the relevant base as the center, based on a base pair probability matrix.

The base pair probability total of the loop parameter may include a total of base pair probabilities corresponding to base pairs sequentially located on outer sides when, assuming that the number of bases in the loop section is an even number, the relevant base and a base next to the relevant base are set as a first base pair.

The loop parameter may be a weighted average of a plurality of the base pair probability totals respectively corresponding to a plurality of bases in a predetermined range around the relevant base.

The microRNA-model storing unit may further store a non-microRNA model, which is a probability model generated from a non-microRNA group known as not corresponding to microRNA, and the microRNA detecting unit may detect a region matching the microRNA model and not matching the non-microRNA model as the microRNA region.

The microRNA-model storing unit may store a plurality of the non-microRNA models respectively generated from a plurality of non-microRNA groups having different degrees of evolutional conservation.

The stem parameter may include a parameter representing a probability that the relevant base is located in the stem section on a 5′ side and a parameter representing a-probability that the relevant base is located in the stem section on a 3′ side.

According to another aspect of the present invention, there is provided a microRNA detecting method of detecting a microRNA region by processing base sequence information with a computer, the microRNA detecting method comprising performing processing for: inputting base sequence information of a detection processing target: generating, from the base sequence information of the detection processing target, base vector sequence data formed by a plurality of base vectors respectively corresponding to a plurality of bases included in a sequence, each of the base vectors including a plurality of kinds of parameters that characterize microRNA; and detecting, using a microRNA model that is a probability model of a base vector sequence group including a plurality of the base vector sequence data respectively corresponding to a plurality of known microRNAs in a known microRNA group, a region matching the microRNA model from the base sequence of the detection processing target as a microRNA region, wherein the plurality of kinds of parameters of each of the base vectors forming the base vector sequence data include a conservation score parameter representing a degree of evolutional conservation in a relevant base of each of the base vectors and secondary structural parameters characterizing a stable hairpin structure, and the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.

According to another aspect of the present invention, there is provided with a microRNA detecting program for causing a computer to execute microRNA detection processing for detecting a microRNA region from base sequence information, the microRNA detecting program causing the computer to execute processing for: generating, from inputted base sequence information of a detection processing target, base vector sequence data formed by a plurality of base vectors respectively corresponding to a plurality of bases included in a sequence, each of the base vectors including a plurality of kinds of parameters that characterize microRNA; and detecting, using a microRNA model that is a probability model of a base vector sequence group including a plurality of the base vector sequence data respectively corresponding to a plurality of known microRNAs in a known microRNA group, a region matching the microRNA model from the base sequence of the detection processing target as a microRNA region, wherein the plurality of kinds of parameters of each of the base vectors forming the base vector sequence data include a conservation score parameter representing a degree of evolutional conservation in a relevant base of each of the base vectors and secondary structural parameters characterizing a stable hairpin structure, and the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.

The present invention may be represented by another aspect other than the microRNA detecting apparatus. The present invention may be represented by, for example, an aspect of the method or the program described above or may be a computer-readable recording medium having the program recorded therein. Still another aspect of the present invention may be the microRNA model generating or creating apparatus, method, program, or recording medium. A non-microRNA model may be created in addition to the microRNA model. Still other aspects of the present invention may include the various additional features described concerning the aspect of the microRNA detecting apparatus.

According to the present invention, it is possible to improve the performance or accuracy of detection of microRNAs using the microRNA model.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a block diagram of a microRNA detecting apparatus according to an embodiment of the present invention;

FIG. 2 is a diagram of a base vector sequence data;

FIG. 3 is a schematic diagram of a value of a parameter CS along one miRNA;

FIG. 4 is a schematic diagram of a value of a parameter Z-SCORE along one miRNA;

FIG. 5 is a schematic diagram of values of parameters PL and PR along one miRNA;

FIG. 6 is a diagram of processing for calculating the parameter PL;

FIG. 7 is a diagram of processing for calculating the parameter PR;

FIG. 8 is a schematic diagram of a value of a parameter VI along one miRNA;

FIG. 9 is a diagram of processing for calculating the parameter V′;

FIG. 10 is a diagram of a bulge in a stem that is taken into account in the processing for calculating the parameter V′.

FIG. 11 is a diagram of an example of five kinds of parameters along one miRNA:

FIG. 12 is a diagram of a method of creating a miRNA model and non-miRNA models;

FIG. 13 is a diagram of the overall architecture of the HMM in this embodiment;

FIG. 14 is a diagram of an example of the architecture of the miRNA model; and

FIG. 15 is a diagram of an example of the architecture of the non-miRNA.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

In this embodiment, pre-miRNA is detected as microRNA. In the following explanation, the detected pre-miRNA is described as miRNA.

As an overview, a new technique for detecting miRNA based on the Hidden Markov Model (HMM) is proposed. In this technique, conservation and secondary structural features of miRNA and surrounding regions thereof are represented by a sequence of multi dimensional vectors of continuous values. The HMM generating a sequence of continuous values, called a continuous HMM, is used to model features around miRNA. In this prediction technique, two types of secondary structural features, i.e., Z-score of minimum free energy and a base pair probability matrix, are used. Combination of such secondary structural features enhances prediction performance. In this prediction technique, miRNAs are predicted based on a single measure of log-likelihood probability derived by integrating multiple features. Therefore, the prediction technique is advantageous compared with the pipeline technique in the past including a plurality of steps. That is, whereas the pipeline technique in the past is affected by the introduction of an arbitrary threshold assigned to each of the plurality of steps, the present invention can minimize such influence of the introduction of the threshold. Moreover, in this prediction technique, variation in length of miRNAs can be modeled, which is an advantage over SVM based methods in which a fixed length window size is used.

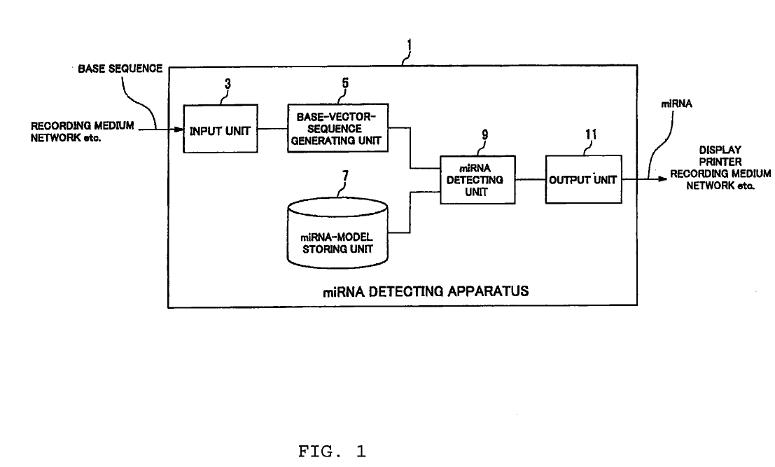

FIG. 1 is a block diagram of a configuration of a miRNA detecting apparatus according to this embodiment. In FIG. 1, the miRNA detecting apparatus 1 is a computer apparatus. The miRNA detecting apparatus 1 includes a CPU as an arithmetic device, storage devices such as a RAM and a ROM, input devices such as a keyboard and a pointing device, output devices such as a display and a printer, and an external storage device such as a hard disk. The miRNA detecting apparatus 1 has a function for communication with a network and the like. This communication function may function as information input and output unit.

The miRNA detecting apparatus 1 is configured to be inputted with base sequence information of a detection processing target, execute a program stored therein to thereby process the base sequence information and detect miRNA regions, and output a detection result. As shown in FIG. 1, the miRNA detecting apparatus 1 includes an input unit 3, a base-vector-sequence generating unit 5, a miRNA-model storing unit 7, a miRNA detecting unit 9, and an output unit 11.

The input unit 3 is realized by the input device of the miRNA detecting apparatus 1 and inputs the base sequence information of the detection processing target. The base sequence information may be read in the miRNA detecting apparatus 1 from, for example, a recording medium. In this case, reading and writing means for the recording medium functions as the input device. The base sequence information of the detection processing target is base sequence information of a detection source of miRNA, for example, data of the human genome.

The base-vector-sequence generating unit 5 generates base vector sequence data (i.e. data of a sequence of base vectors) from the base sequence information inputted by the input unit 3. The base-vector-sequence generating unit 5 is realized by the arithmetic function of the miRNA detecting apparatus 1 and executes the program stored in the miRNA detecting apparatus 1 to obtain base vector sequence data. The base vector sequence data is a sequence of a plurality of base vectors respectively corresponding to a plurality of bases included in the base sequence information of the detection processing target. Each of the base vectors includes a plurality of kinds or types of parameters that characterize miRNA. The plurality of parameters are described later.

The miRNA-model storing unit 7 is configured by the storage device of the miRNA detecting apparatus 1 and stores a miRNA model generated from a known miRNA group. The miRNA model is a probability model that represents features of a base vector sequence group including a plurality of base vector sequence data respectively corresponding to a plurality of known miRNAs in the known miRNA group. In this embodiment, the miRNA model is the Hidden Markov Model (hereinafter referred to as HMM).

The miRNA-model storing unit 7 also stores a non-miRNA model generated from a non-miRNA group known as not corresponding to miRNA. The non-miRNA model is also the HMM. The miRNA model and the non-miRNA model are coupled such that states thereof can be transitioned.

The miRNA detecting unit 9 is realized by the arithmetic function of the miRNA detecting apparatus 1 and executes the program stored in the miRNA detecting apparatus 1 to thereby detect miRNA regions. The miRNA detecting unit 9 detects, based on the base vector sequence data generated by the base-vector-sequence generating unit 5 and the miRNA model of the miRNA-model storing unit 7, a region matching the miRNA model from the base sequence of the detection processing target as a miRNA region. More specifically, the miRNA detecting unit 9 detects a region matching the miRNA model and not matching the non-miRNA model as a miRNA region.

The output unit 11 outputs information concerning the miRNA regions detected by the miRNA detecting unit 9. The output unit 11 is realized by the output device of the miRNA detecting apparatus 1. A detection result may be outputted to the display or the printer The detection result may be written in the recording medium. In this case, the reading and writing means for the recording medium functions as the output device.

The miRNA detecting apparatus 1 may be configured by a single computer or may be configured by a plurality of computers. The plurality of computers may be distributedly arranged.

The base sequence information of the detection processing target may be inputted from an external terminal apparatus or the like by using the communication function of the miRNA detecting apparatus 1. Similarly, the information concerning miRNAs of the detection result may be outputted to the outside by using the communication function. In this case, the communication function functions as an input and output unit. The miRNA detecting apparatus 1 may transmit data to and receive data from a network using the communication function. In this case, the miRNA detecting apparatus 1 may be inputted with the base sequence information and return the information concerning the detection result via the Internet.

The miRNA detecting apparatus 1 will now be explained in more detail. First, base vector sequence data characteristic to this embodiment will be explained. Then, a miRNA model obtained by modeling the base vector sequence data using the HMM will be explained.

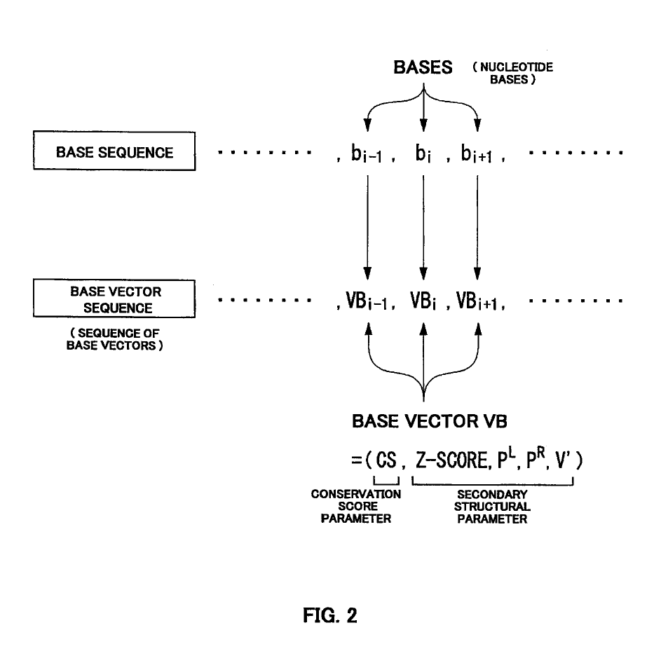

FIG. 2 is a diagram of the base vector sequence data. As shown in the figure, base vectors VBi are obtained in association with respective bases bi of a base sequence. Each base vector VBi is a vector of a plurality of dimensions having a plurality of kinds of parameters, which characterize miRNA, as vector elements. The base vector sequence data is data of a sequence of base vectors. In this embodiment, each of the base vectors is the five-dimensional vector including five kinds of parameters (CS, Z-SCORE, PL, PR, and V′), accordingly the base vector sequence data is data of the sequence of five-dimensional vectors.

The five parameters of the base vector are roughly divided into a conservation score parameter and secondary structural parameters. The conservation score parameter is a parameter representing degrees of evolutional conservation around the respective bases. The secondary structural parameters are parameters that characterize a stable hairpin structure. The secondary structural parameters are set based on features of the stable hairpin structure. The CS corresponds to the conservation score parameter. The Z-SCORE, PL, PR, and V′ correspond to the secondary structural parameters. MiRNAs are highly conserved among vertebrates (mammals, birds, fish, etc.) and have an extremely stable hairpin structure. Therefore, features of miRNAs are represented by the parameters. The respective parameters are explained in detail below.

“Parameter CS”

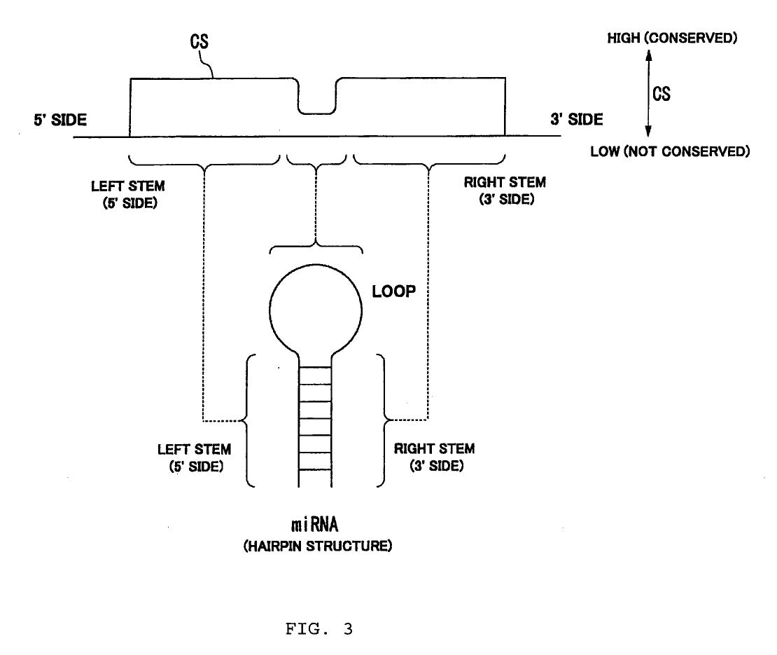

FIG. 3 is a schematic diagram of a value of the parameter CS along one miRNA. The parameter CS is an abbreviation of conservation score and is a parameter of a degree of evolutional conservation that can be calculated by a phastCons program. The parameter CS corresponds to the conservation score parameter of the present invention. CS represents a value between 0 and 1. A conservation degree becomes higher as CS becomes larger.

As shown in a lower part of FIG. 3, miRNA has a hairpin structure including a stem section and a loop section. The stem section on a 5′ side, the loop section, and the stem section on a 3′ side are located side by side on a sequence. The stem section on the 5′ side and the stem section on the 3′ side are coupled as shown in the figure. In the following explanation, as shown in FIG. 3, the 5′ side is arranged on the left, while the 3′ side is arranged on the right, with the stem section on the 5′ side being referred to as a left stem section, and the stem section on the 3′ side being referred to as a right stem section.

In miRNA, the left stem section, the loop section, and the right stem section are located in order as described above. In general, mutation rarely occurs in the stem section and often occurs in the loop section. Therefore, in the case of miRNA, as shown in the figure, CS tends to be high in the left stem section, low in the loop section, and high in the right stem section.

The conservation degree will be further explained. The conservation degree is calculated by comparing DNAs of various kinds of biological species. DNAs of vertebrates such as mammals, birds, and fish are suitably compared. In a region where the conservation degree is high, similarity of sequences among the biological species is high. In a region where the conservation degree is low, similarity of sequences among the biological species is low. Various studies concerning the conservation degree have already been conducted from such a viewpoint.

In the case of this embodiment, as described above, CS calculated by the phastCons program is used as the conservation score parameter. Data of CS of a base sequence of a detection processing target may be inputted and stored and the data of CS may be used as the conservation score parameter. The data of CS may be inputted by download or the like through the network. In this embodiment, the base sequence of the detection processing target is, for example, the human genome. In this case, CS over the entire human genome has already been calculated and opened to the public on the network. The CS may be downloaded, stored in the miRNA detecting apparatus 1, and used.

Alternatively, a calculation program for the conservation degree may be stored in the miRNA detecting apparatus 1 and executed by the base-vector-sequence generating unit 5 and the CS may be calculated from the base sequence. In this case, the inputted base sequence of the detection processing target is compared with a genome of other biological species and homologous regions are obtained. The homologous regions are collected to form a multiple alignment. The multiple alignment is given as an input of the calculation program and the CS is calculated.

“Parameter Z-SCORE”

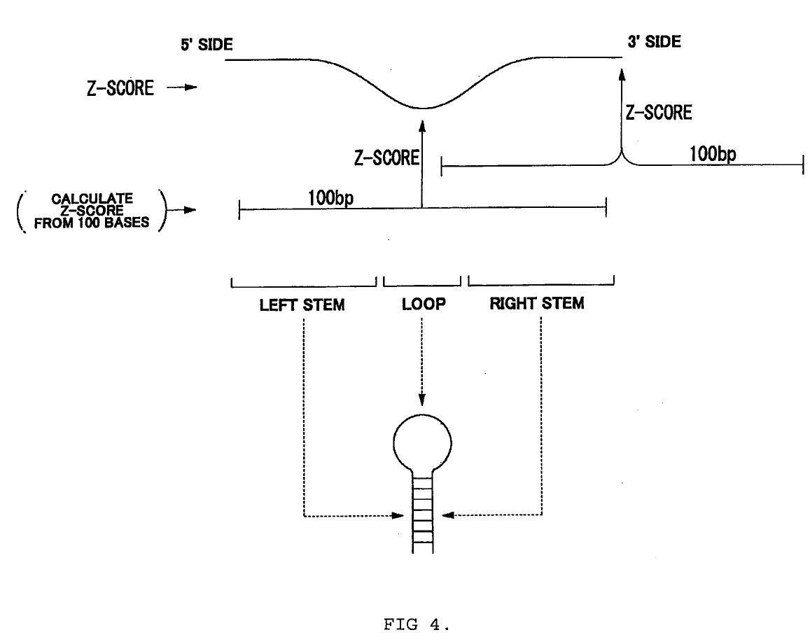

FIG. 4 is a schematic diagram of a value of the parameter Z-SCORE along one miRNA. The parameter Z-SCORE is one parameter among parameters concerning a secondary structure and is a parameter representing the magnitude of minimum free energy. In this embodiment, in particular, Z-SCORE is a parameter representing the magnitude of minimum free energy in surrounding regions of the respective bases and corresponds to the energy parameter of the present invention.

The minimum free energy is free energy of a secondary structure having the lowest free energy among secondary structures that a certain base sequence can take. The minimum free energy is small in a stable structure. Therefore, the smaller the minimum free energy, the more stable the structure of the base sequence. The minimum free energy can be calculated by the Zuker algorithm. In this embodiment, a calculation program for the algorithm is stored in the miRNA detecting apparatus 1 and executed by the base-vector-sequence generating unit 5, and thus S-SCORE is calculated from the base sequence.

Z-SCORE of the minimum free energy can be represented by the following formula:

Z=(E−<E>)/σ

where, E represents minimum free energy of a given sequence. <E> and σ represent mean and standard deviation of minimum free energy of random sequences having a base composition the same as that of the given sequence.

In the above formula, Z-SCORE is represented as a deviation value by using the mean and the standard deviation of the random sequences. Thus, using the deviation value can reduce the influence of a difference in coupling strength of a base pair of “a” and “t” and a base pair of “g” and “Ic” and appropriately represent structural stability.

Referring to FIG. 4, in this embodiment, Z-SCORE of the respective bases is calculated so as to obtain the Z-SCORE obtained from a sequence in a predetermined range around the base of attention. This predetermined range is set to a range of 100 bp around the base of attention, That is, Z-SCORE of bases of 100 bp is calculated one after another while the bases are shifted by one base each time.

When Z-SCORE of miRNA is calculated, as shown in the figure, Z-SCORE decreases from the periphery of the miRNA to the center thereof. This is because, in miRNA, the structure is stable and free energy is small. For example, at an end of miRNA, a half of a one-hundred base sequence, for which Z-SCORE is calculated, is on the outside of miRNA. On the other hand, in the center of miRNA, most of the one-hundred base sequence is within miRNA (in general, the length of miRNA is about one-hundred bases). Therefore, Z-SCORE is smaller in the center of miRNA.

“Parameters PL and PR”

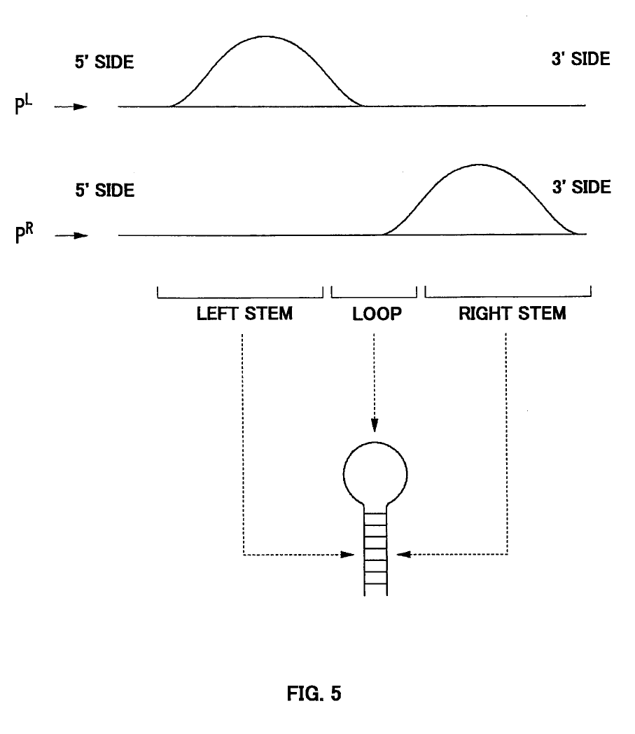

FIG. 5 is a schematic diagram of values of the parameters PL and PR along one miRNA. The parameters PL and PR are two parameters among the parameters concerning the secondary structure and, in particular, parameters representing levels of possibility that respective bases are located in a stem section of a hairpin structure of miRNA. The parameters PL and PR are represented based on a base pair probability and correspond to the stem parameter of the present invention. In this embodiment, specifically, the parameters PL and PR represent levels of probabilities that the respective bases are located in the stem section. The parameters PL and PR respectively represent probabilities that the respective bases are located in the left stem section (the 5′ side stem section) and the right stem section (the 3′ side stem section). In other words, the parameter PL is a probability of forming a base pair with a complementary base located on the right side. The parameter PR is a probability of forming a base pair with a complementary base located on the left side. In this embodiment, the parameters PL and PR are calculated as described below.

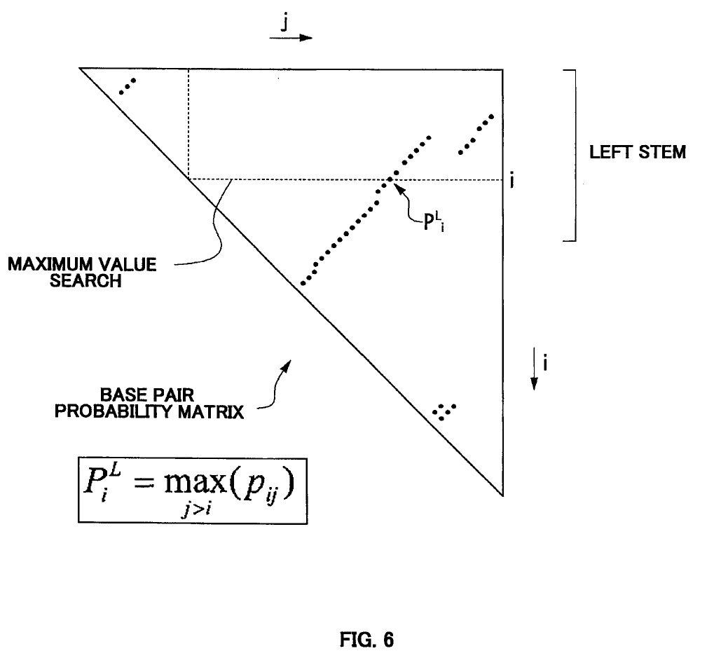

FIG. 6 is a diagram for explaining the process for calculating the parameter PL. The parameter PL is calculated by using a base pair probability matrix as shown in the figure. In the base pair probability matrix, as is well-known, two sequences are arranged in a row direction and a column direction. Probabilities of all arbitrary base pairs obtained from the two sequences are represented by a matrix. The probability is the base pair probability. The probability is represented as, for example, the size of dots as shown in the figure. Actual base pair probability matrix data is a table of probability values corresponding to the respective dots on the matrix.

In this embodiment, the same base sequences are arranged in two directions, the base pair probabilities shown in FIG. 6 are calculated, and the parameter PL is calculated from the base pair probabilities.

In FIG. 6, when the parameter PL of a base i is represented as PLi, PLi is a maximum probability value obtained in the sequence area in the right direction from the base i. This is a maximum value of a probability of a base pair formed by the base i and an arbitrary base further on the right side (the 3′ side) than the base i. As the specific process, the largest probability is extracted from the values along the horizontal maximum value search line in FIG. 6. In an example shown in the figure, the base i is located in the left stem section.

When the base i is located in the left stem section, the base i forms a pair with any one of the bases on the right side, therefore, the parameter PLi is large. As a result, as shown in FIG. 5, the parameter PL is large in the left stem section.

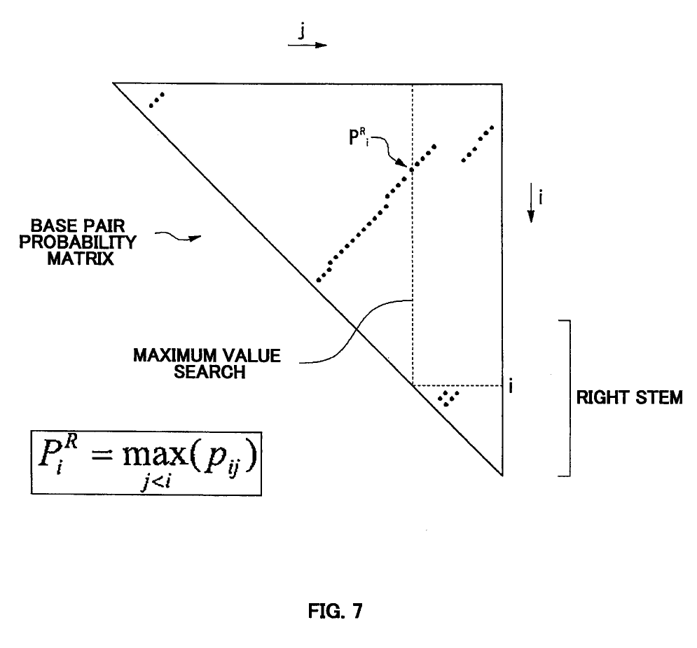

FIG. 7 is a diagram for explaining the process for calculating the parameter PR. The parameter PR is calculated by using a base pair probability matrix same as that shown in FIG. 6.

In FIG. 7, when the parameter PR of the base i is represented as PRi, PRi is a maximum probability value obtained in the sequence area in the upper direction from the base i in the matrix of FIG. 7. This is a maximum value of a probability of a base pair formed by the base and an arbitrary base further on the left side (the 5′ side) than the base i. As the specific process, the largest probability is extracted from the values along the vertical maximum value search line in FIG. 7. In an example shown in the figure, the base i is located in the right stem. When the base i is located in the right stem in this way, the base i forms a pair with any one of the bases on the left side, and therefore the parameter PRi is large. As a result, as shown in FIG. 5, the parameter PR is large in the right stem section.

The parameters PLi and PRi are represented by the following formulas:

$${P}_{i}^{L} = {max}_{j > i} ( {p}_{ij} )$$

$${P}_{i}^{R} = {max}_{j < i} ( {p}_{ij} )$$

where, pij represents a base pair probability of the base and a base J.

In this embodiment, a calculation program for the base pair probability matrix as mentioned above is stored in the miRNA detecting apparatus 1. This calculation program is executed by the base-vector-sequence generating unit 5, and as a result the base-vector-sequence generating unit 5 calculates the parameters PL and PR from the base pair probability matrix using the formulas.

“Parameter V′”

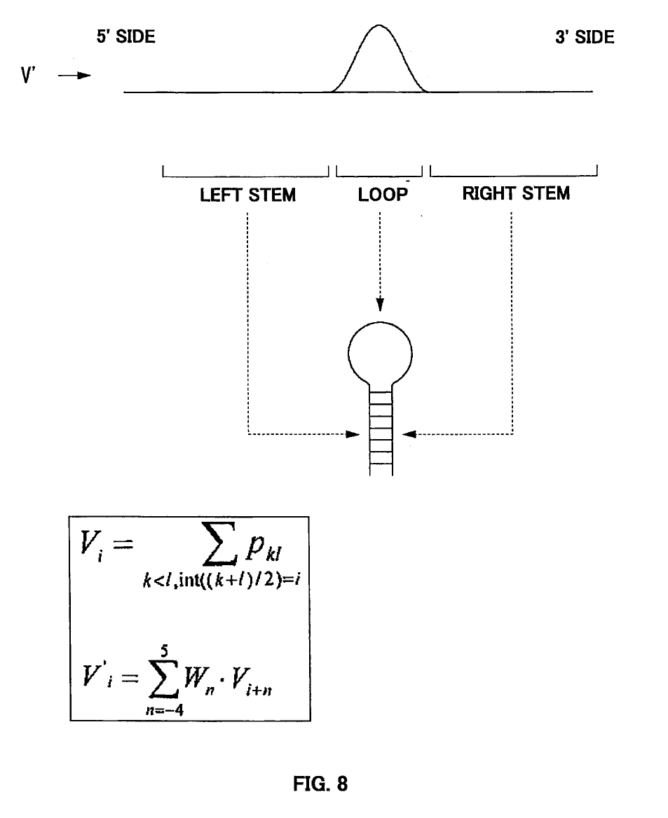

FIG. 8 is a schematic diagram of a value of the parameter V′ along one miRNA. The parameter V′ is one parameter among the parameters concerning the secondary structure. In particular, the parameter V′ is a parameter representing a level of possibility that respective bases are located in a loop section of a hairpin structure of miRNA. The parameter VI is represented based on a base pair probability and corresponds to the loop parameter of the present invention. More specifically, the parameter V′ represents a level of a probability that a base is located in the loop section. The parameter V′ is calculated by using a base pair probability matrix the same as that used in the calculation of the parameters PL and PR as described below.

In this embodiment, when the parameter V′ of the base i is represented as V′i, Vi is represented by the following formulas:

$${V}_{i} = {\sum }_{k < l , int ( ( k + l ) / 2 ) = i} {p}_{kl}$$

$${V}_{i}^{′} = {\sum }_{n = - 4}^{5} {W}_{n} \cdot {V}_{i + n}$$

where, pkl represents a base pair probability of a base k and a base l. Int( ) represents a function for omitting a decimal component. Wn represents a weight coefficient. W₋₄, W₋₃, . . . , W₊₄, W₅₊={1/30, 2/30, 3/30, 4/30, 5/30, 5/30, 4/30, 3/30, 2/30, 1/30).

As indicated by the formulas, the parameter V′i is a weighted average of the parameter Vi. First, processing for calculating the parameter Vi will be explained.

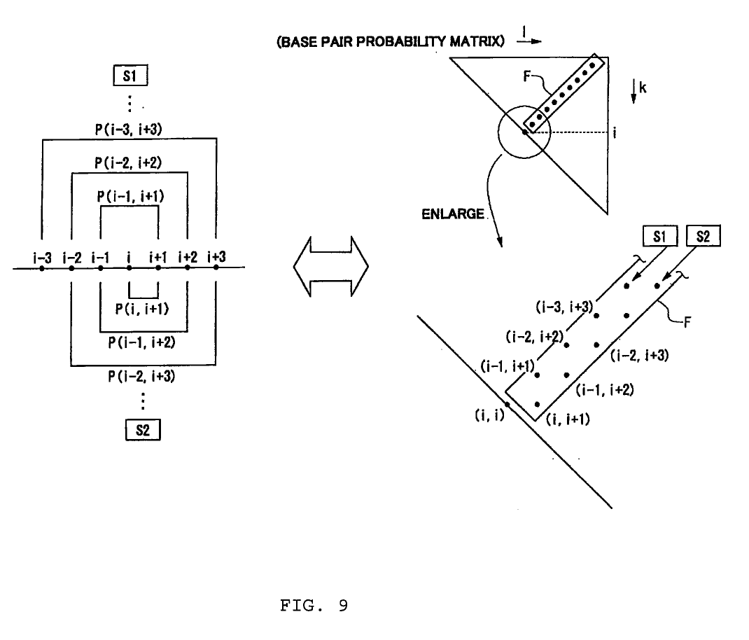

FIG. 9 is a diagram for explaining the processing for calculating the parameter Vi of the base i. In the above-mentioned formulas of the parameter Vi, for designation of P as an addition target, the function Int for omitting a decimal component is used. Consequently, as specifically shown in the left half of FIG. 9, the parameter Vi takes a value equivalent to a sum of “total S1” and “total S2” described below.

“Total S1” is a total of probabilities of base pairs sequentially located on outer sides with the base i set as the center. Specifically, S1 is the total of P(k, l)=P(i−1, i+1), P(i−2, i+2), P(i−3, i+3), . . . .

“Total S2” is a total of probabilities of base pairs sequentially located on outer sides with bases i and i+1 set as the first base pair (i.e. the center). Specifically, S2 is the total of P(k, l)=P(i, i+1), P(i−1, i+2), P(i−2, i+3), . . . .

As shown in the right half of FIG. 9, on a base pair probability matrix, the parameter V is equivalent to a sum of base pair probabilities arranged in an upper right oblique direction from a position corresponding to the base i on a diagonal. More specifically, since the “total S2” is added, the parameter V is equivalent to a sum of base pair probabilities included in a frame F shown in FIG. 9. The frame F surrounds a dot group arranged In the upper right oblique direction from a position of the base i on the matrix and a dot group shifted to the right side by one dot from the former dot group.

Next, processing for calculating the parameter V′i from the parameter Vi is explained. As indicated by the above-mentioned formulas, the parameter V′i is a weighted average of the plurality of parameters Vi of the base i and bases around the base i. Parameters Vi₋₄ to Vi₊₅ of ten bases around the base i are used. A weight coefficient is generally increased closer to the base i in the center. Specifically, the weight coefficient is (1/30, 2/30, 3/30, 4/30, 5/30, 5/30, 4/30, 3/30, 2/30, 1/30), that is, weight of a triangular shape is applied.

The processing for calculating the parameter V′ is explained above. By using such a parameter V′, as explained below, features of the loop section are appropriately represented by taking into account both cases in which the length of the loop section is an odd number and the length is an even number.

First, it is assumed that the number of bases in the loop section is an odd number in the hairpin structure of miRNA. In this case, the left stem section and the right stem section are symmetrically located on both sides of the base i at the center of the loop section. Base pair probabilities of the left stem section and the right stem section are extremely high. Therefore, the above-mentioned “total S1” is large with respect to the base i in the center of the loop section. As a result, the parameter V′1 is large.

It is assumed that the number of bases in the loop section is an even number. In this case, there are two bases at the center of the loop section. The above-mentioned “total S2” is large with respect to the base i on the left side of these two bases, and as a result, the parameter V′i is large. In this way, in this embodiment, since the “total S2” is used, the parameter V′l of the base at the center of the loop section is large even when the number of bases in the loop section is an even number. Therefore, this embodiment can cope with a case in which the number of bases in the loop section is an even number.

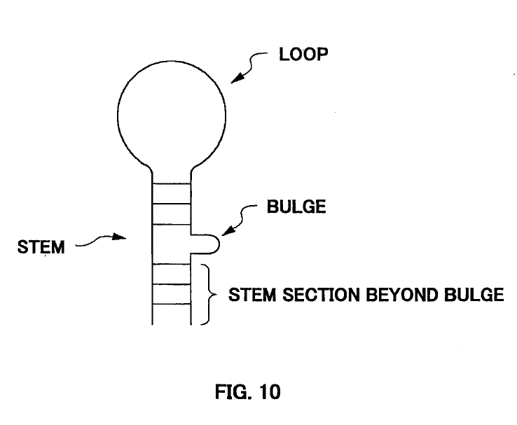

Moreover, since the weighted average is performed, this embodiment can suitably cope with a case in which a bulge section shown in FIG. 10 is included in the stem section. When the bulge section is present, symmetry of the stem section around the loop section is lost in a portion beyond the bulge section. Therefore, if the parameter V is simply calculated, base pair probabilities of the stem section beyond the bulge section are not satisfactorily reflected in the parameter V. However, in this embodiment, the parameter V′ is finally calculated by weight averaging the parameter V in surrounding regions. According to the weighted average, a level of the base pair probabilities in the stem section beyond the bulge section can be reflected in the parameter V′. Therefore, this embodiment can suitably cope with a case in which a bulge is present.

The parameter V′ obtained as described above is large with respect to the base at the center of the loop section. Since the weighted average is performed, the parameter V′ is large even at bases around the center of the loop section. On the other hand, the parameter V′ is small at bases away from the center of the loop section. As a result, as shown in the figure, the parameter V′ in miRNA is small in the stem section, increases closer to the center of the loop section, and is largest near the center of the loop section.

In the configuration shown in FIG. 1, the parameter V′ is calculated by the base-vector-sequence generating unit 5. A base pair probability matrix is calculated and the parameter V′ is calculated according to the formulas described above. The base pair probability matrix may be the same as that used for calculating the parameters PL and PR.

The use of the parameter V′ is one of advantage of this embodiment. In the miRNA detection technique in the past, attention is paid mainly to the stem section. However, an appropriate parameter obtained by paying attention to the loop section is not used. In this embodiment, the new parameter V′ that characterizes the loop section is proposed, and therefore performance and accuracy of detection of miRNA are improved by using this suitable parameter V′.

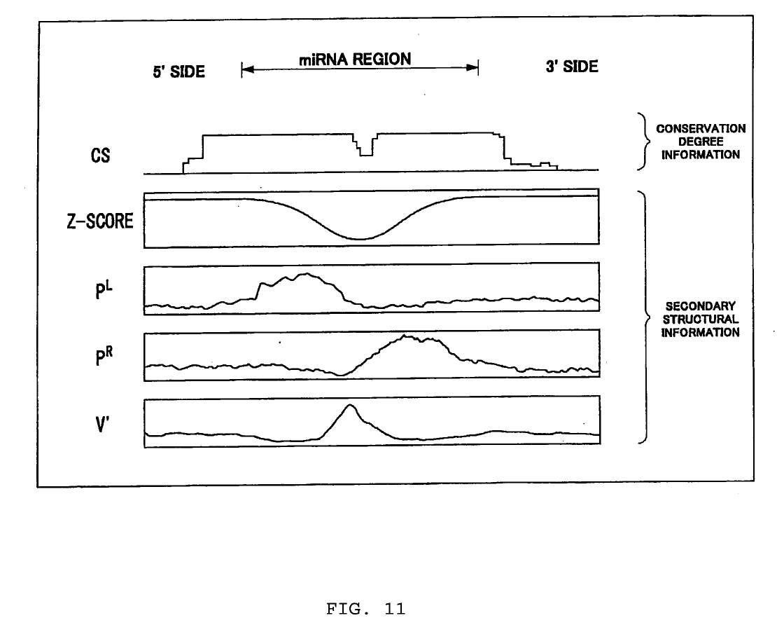

The five parameters included in the base vector in this embodiment are explained above. FIG. 11 is a diagram of an example of the five parameters in one miRNA and surrounding regions thereof. As shown in the figure, in this embodiment, five parameters corresponding to respective base of a base sequence are calculated. According to the five parameters, base vectors of the respective bases are calculated. Base vector sequence data is obtained by arraying the base vectors. The base vector sequence data is used for creation of a miRNA model and processing for detecting miRNA using the miRNA model.

“miRNA Model and Non-miRNA Model”

A miRNA model and a non-miRNA model created by using the base vector sequence data are explained. Generally, known miRNAs are collected, base vector sequence data is generated from each miRNA, and the base vector sequence data is modeled by using the Hidden Markov Model (hereinafter, HMM), thereby generating a miRNA model. Similarly, a non-miRNA is generated from a sequence group other than miRNA.

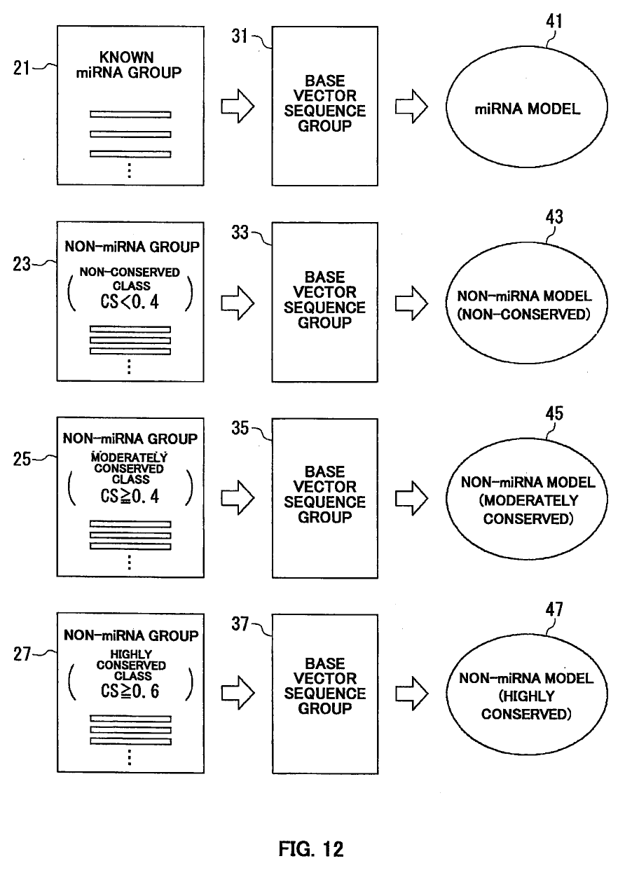

FIG. 12 is a diagram of a method of creating a miRNA model and non-miRNA models. In FIG. 12, the known miRNA group 21 is a set of known miRNAs. The length of miRNAs does not have to be fixed. Base vector sequence data is generated from each miRNA of the known miRNA group. Consequently, a base vector sequence group 31 is obtained. A miRNA model 41, which is the HMM, is then generated from the base vector sequence group 31. In a model generation process, a HMM learning processing is performed and a probability model is generated.

Referring to FIG. 11 again, as described above, in the case of an example shown in the figure, the five parameters are calculated from the region including the miRNA and surrounding regions on both sides of the miRNA. The regions added to both sides are regions of 50 bp in the example shown in the figure. Taking into account the fact that the length of miRNA is generally about 100 bp, total length including the surrounding regions is about 200 bp. When a base vector sequence is actually created and modeled in the scope of the present invention, the base vector sequence may be generated from the region including the miRNA and the surrounding regions thereof and a miRNA model may be generated from this base vector sequence.

Thus, the region including miRNA and the surrounding regions thereof may be processed as regions of microRNA in the scope of the present invention. Base vector sequence data obtained from miRNA including the surrounding regions may be used as base vector sequence data corresponding to the miRNA model.

Referring back to FIG. 12, the non-miRNA model is explained. The non-miRNA model is the HMM like the miRNA model. Concerning the non-miRNA model, three models are generated as shown in FIG. 12.

In FIG. 12, non-miRNA groups 23, 25, and 27 are sets of non-miRNA sequences. The non-miRNA sequences are sequences considered not corresponding to miRNA. The non-miRNA groups 23, 25, and 27 are different in degrees of evolutional conservation of the sequences. In the non-miRNA group 23, a conservation degree is low (a non-conserved class). In the non-miRNA group 25, a conservation degree is medium (a moderately conserved class). In the non-miRNA group 27, a conservation degree is high (a highly conserved class). Base vector sequence groups 33, 35, and 37 are generated from the non-miRNA groups 23, 25, and 27, respectively. As in the case of the miRNA model, base vector sequence data is generated from the respective sequence. Non-miRNA models 43, 45, and 47, which are HMMs, are then generated from the base vector sequence groups 33, 35, and 37, respectively.

In this embodiment, although not shown in FIG. 1, a model creating unit may be suitably provided in the miRNA detecting apparatus 1. The model creating unit may perform the model creation processing mentioned above and create the miRNA model 41 and the non-miRNA models 43, 45, and 47. The model creating unit has a configuration for creating the HMM using a HMM learning function and a model creating function. The model creating unit is realized by executing a HMM program stored in the miRNA detecting apparatus 1. The model creating method explained with reference to FIG. 12 is executed. Consequently, a function of the model creating unit in this embodiment is realized, and the miRNA model 41 and the non-miRNA models 43, 45, and 47 are created. As a modification, the model creation may be performed on the outside and created models may be inputted to the miRNA detecting apparatus 1, stored, and used.

In a specific example of this embodiment, 290 miRNAs with high conservation degrees were selected as a known miRNA group 21 out of 464 known miRNAs. The miRNA model 41 was created from the 290 miRNAs. 3000 regions not considered to be miRNA on the human genome were selected and the non-miRNA groups 23, 25, and 27 were created. In this process, one thousand sequences were selected for each of the groups by using the parameter CS as an index of conservation degree. CS of the non-conserved class was set to be lower than 0.4. CS of the moderately conserved class was set to be equal to or higher than 0.4. CS of the highly conserved class was set to be equal to or higher than 0.6. All sequence lengths of non-miRNAs were set to 200 bp. It was found that a detection result was obtained at high accuracy by using such a setting example.

In the example described above, CS of the moderately conserved class is set to be equal to or higher than 0.4 and an upper limit thereof is not set. Therefore, regions with high conservation degrees can be included in the moderately conserved class. That is, regions with CS equal to or higher than 0.6 may be mixed in the moderately conserved class. However, in general, the number of regions of the highly conserved class is small compared to the number of regions of the moderately conserved class. Therefore, only a small number of regions with high conservation degrees are mixed in the moderately conserved class. When one thousand regions with CS equal to or higher than 0.4 are collected as described above, only a few regions with a conservation degree equal to or higher than 0.6 are mixed. Therefore, even if an upper limit of CS of the moderately conserved class is not specified, it is possible to create the non-miRNA group 25 that is sufficiently appropriate as the moderately conserved class.

The miRNA model and the non-miRNA models are used for miRNA detection as described below. The miRNA model and the non-miRNA models are stored in the miRNA-model storing unit 7 shown in FIG. 1. The miRNA detecting unit 9 detects a miRNA region on a base sequence of a detection processing target using a base vector sequence of the detection processing target and the models stored in the miRNA-model storing unit 7. As the process of detection of the miRNA region, a region matching the miRNA model and not matching the non-miRNA models is detected.

As the detection algorithm for processing the HMM, a Viterbi algorithm for performing “Viterbi decoding” is suitably used. The Viterbi algorithm is an algorithm for estimating a state sequence from an observed character sequence. The Viterbi algorithm is used for a synthetic analysis, and therefore the same principle can be used for a sequence analysis for a base and the like. The Viterbi algorithm can find which part of a sequence corresponds to which state. Therefore, with the Viterbi algorithm, it is calculated which part of a detection target sequence corresponds to which internal state of the probability model of the HMM.

In the detection processing, a region having arbitrary length at an arbitrary position included in a detection source base sequence is set as a candidate region. The candidate region is processed by the HMM so that likelihoods obtained when the candidate region is applied to the HMM are calculated. The likelihoods are calculated by using the miRNA model 41 and the three non-miRNA models 43, 45, and 47. A model that the candidate region matches is found based on the four likelihoods. Conceptually, it is judged that the candidate region matches a model having maximum likelihood and does not match the other models. If the candidate region matches the miRNA model, it is predicted that the candidate region is miRNA. Such processing is performed while a position and the length of the candidate region are changed. In this way, miRNA having any length in any position on the base sequence is detected (however, the length of miRNA is limited to an appropriate range, as described later).

In this embodiment, since the HMM is used, it is unnecessary to fix the length of a region of miRNA. That is, miRNA regions having various lengths can be detected. In other words, variable-length miRNA detection can be suitably performed. In this embodiment, a calculation program of the Viterbi algorithm for performing such processing is stored in the miRNA detecting apparatus 1 and executed by the miRNA detecting unit 9 to find a region matching the miRNA model on the base sequence.

In this embodiment, as described above, the plurality of kinds of non-miRNA models having different conservation degrees, i.e., the non-conserved class, the moderately conserved class, and the highly conserved class, are used as described above. This is advantageous in the points described below.

As is well known, a conservation degree is low in most portions on a genome. Therefore, if a non-miRNA sequence group is simply created at random, sequences having low conservation degrees occupy most of the non-miRNA sequence group. It is assumed that a non-miRNA model created from such a sequence group is used together with the miRNA model. In this case, contribution of a conservation degree is large in judgment on which of the miRNA model and the non-miRNA models the miRNA candidate region matches. As a result, contribution of structural stability becomes relatively low.

On the other hand, in this embodiment, the non-miRNA model is also created from a non-miRNA group with high conservation degrees. Consequently, it is possible to prevent contribution of a conservation degree from becoming excessive and suitably perform detection based on both the conservation degree and the structural stability.

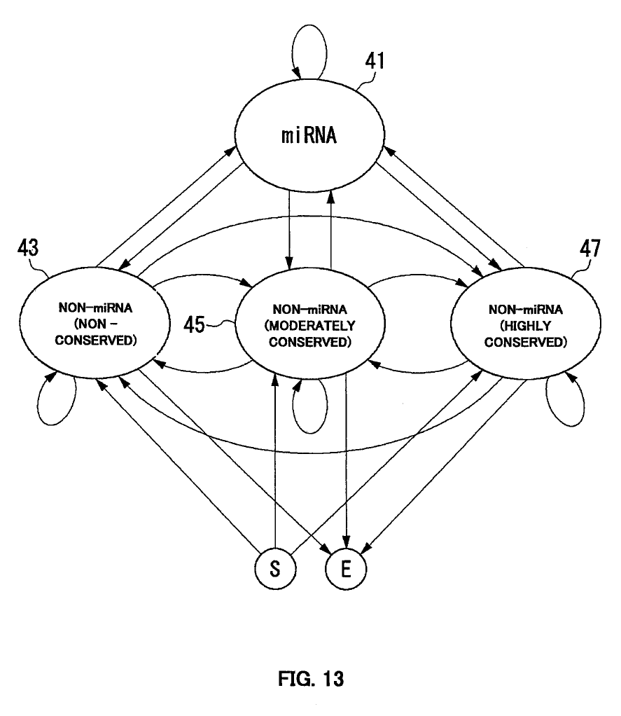

FIG. 13 is a diagram of the overall architecture of the HMM used in this embodiment. Since the HMM has a modular nature, models can be connected such that a state can be transitioned. Making use of this nature, in an actual system, the miRNA model 41 and the non-miRNA models 43, 45, and 47 may be connected as shown in the figure. Such a combined model is stored in the miRNA-model storing unit 7 and processed by the miRNA detecting unit 9. In this way, a region matching the miRNA model 41 and not matching the non-miRNA models 43, 45, and 47 is detected.

The HMM shown in FIG. 13 will be further explained. When miRNA is detected, a large number of candidate regions are processed while the position and length are changed on the base sequence. Likelihoods that respective candidate regions belong to the miRNA model 41 and the non-miRNA models 43, 45, and 47 are calculated. That is, four likelihoods are calculated from the four models with respect to one candidate region. Conceptually, the four models attempt to obtain the candidate region based on the likelihoods. The candidate region is obtained by a model having maximum likelihood. It is assumed that transition among the models occurs in a process for sequentially processing a plurality of candidate regions. When transition from any one of the non-miRNA models 43, 45, and 47 to the miRNA model 41 occurs, the candidate region is detected as a miRNA region. At this point, the candidate region matches the miRNA model 41 and does not match the non-miRNA models 43, 45, and 47. Conversely, when transition from the miRNA model 41 to the non-miRNA models 43, 45, and 47 occurs, the candidate region is a non-miRNA sequence.

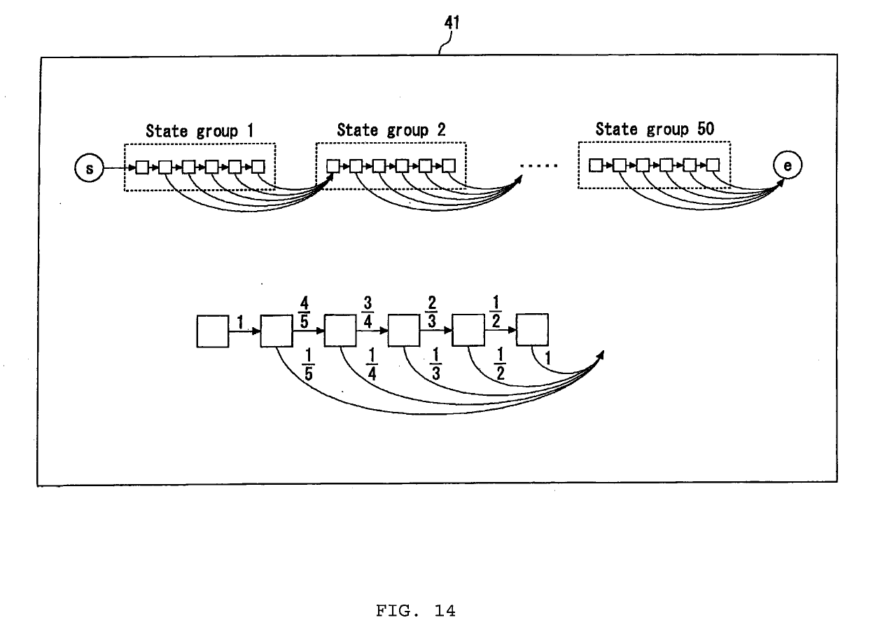

FIG. 14 is a diagram of a suitable example of the architecture of the miRNA model. In miRNA, a plurality of state groups are arranged and connected linearly between a start state “s” and an end state “e”. In this embodiment, the number of state groups is fifty The start state “s” is on a 5′ side of a sequence and the end state “e” is on a 3′ side of the sequence.

In each of the state groups, a plurality of states are connected to be capable of transitioning. As shown in the figure, second and subsequent states are connected to be capable of transitioning to a top state of the next state group. In this embodiment, the number of states of each of the state groups is six. Second to sixth states are coupled to be capable of transitioning to a top state of the next state group.

In each of the state groups, the same probability distribution is attached to the six states. The probability distribution is a mixed normal distribution. Specifically, means, variations, and weights of a mixed distribution may be allocated to the states. Probability distributions may be different among the state groups.

In each of the state groups, transition probabilities among the states are set as shown in the figure. Transition probabilities among the six states are 1, 4/5, 3/4, 2/3, and 1/2, in order. Transition probabilities from second to sixth states to the next group are 1/5, 1/4, 1/3, 1/2, and 1, respectively.

It is assumed that, for example, likelihood of a candidate region X of miRNA is calculated by using the miRNA model. In this case, a plurality of base vectors in the candidate region X are respectively allocated to a plurality of states along a transition path from the start state “s” to the end state “e”. Probabilities in the respective states are calculated as functions of the respective base vectors. A product of the probabilities along the transition path is calculated and likelihood is calculated according to the product. In the Viterbi algorithm, it is calculated through which path the likelihood is highest with respect to the candidate region X. Then, the maximum value of the likelihood is the likelihood of the candidate region X. This likelihood is compared with likelihood calculated in the non-miRNA models.

In the miRNA model of this embodiment, a minimum of two and a maximum of six states are present on the path in each of the state groups. Fifty state groups are provided between the start state “s” and the end state “e” at both ends. Regardless of a path adopted which leads from the start state “s” to the end state “e”, a minimum of one hundred and a maximum of three hundred states are present on the path. Accordingly, likelihood is calculated from the path passing through the minimum one hundred and maximum three hundred states.

In this way, in this embodiment, the length of state transition of the HMM is limited. This limitation on length means that the length of a sequence of detected miRNA is limited to be equal to or larger than 100 bp and equal to or smaller than 300 bp. This makes it possible to limit the length of detected miRNA to an appropriate predetermined range.

The limitation on length will also be explained. As described already, the length of general miRNA is considered to be about 100 bp. As explained already, in the example shown in FIG. 11, when known miRNA is modeled, the region including miRNA and 50 bp on both sides of the miRNA is processed as miRNA. Therefore, a region of about 200 bp is modeled and the miRNA model is created. When a region matching such a HMM is detected, the length of the detected region is also generally about 200 bp. Therefore, the above-mentioned limitation on length (100 bp to 30 bp) is set in an appropriate range around the detected standard miRNA region.

Concerning the miRNA model, state transition probabilities are set in advance as shown in the figure. Taking into account the fact that the number of samples of miRNA is relatively small, the state transition probabilities are positively set in advance rather than calculating state transition probabilities through learning.

In this embodiment, the state transition probabilities are set as shown in the figure. Regardless of a path passing through one state group, a product of probabilities in one state group is 1/5, i.e., the same value. For example, it is assumed that a path passes through only first and second states, and transitions from the second state to the next state group. In this case, a product of probabilities is 1×1/5=1/5. It is assumed that a path passes through all first to sixth states and transitions to the next state group. In this case, a product of probabilities is 1×4/5×3/4×2/3×1/2×1=1/5. In this way, in this embodiment, a product of state transition probabilities is the same regardless of a state transition path.

By setting the state transition probabilities as described above, the performance or accuracy of detection of miRNA can be improved. A reason for this is considered to be as described below. According to the setting described above, even if the length of detected miRNA is different, a product of state transition probabilities is the same. Consequently, the influence of a difference in length of a candidate sequence of miRNA is appropriately controlled. This makes it possible to suitably perform variable-length microRNA detection.

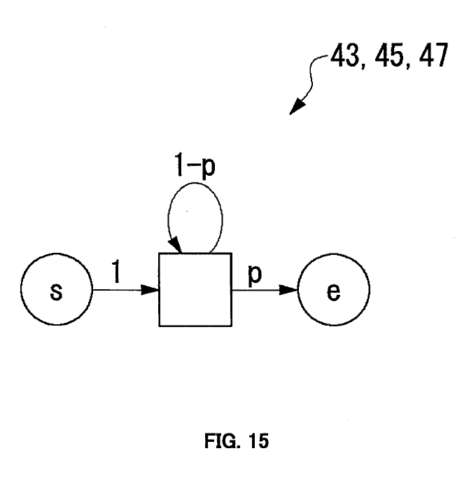

FIG. 15 is a diagram of the architecture of the non-miRNA model. As shown in FIG. 15, the non-miRNA model has an own loop and the same probability distribution is used a plurality of times. Whereas, in the miRNA model shown in FIG. 14, the state transition probabilities are set in advance as shown in the figure, in the non-miRNA model shown in FIG. 15, and a state transition probability “p” is calculated by HMM learning processing. Likelihood of a candidate region is calculated according to the architecture shown in FIG. 15. This likelihood is processed together with the likelihood obtained from the architecture shown in FIG. 14, a model that the candidate region matches is obtained, and detection of miRNA is performed.

The configurations of the respective units of the miRNA detecting apparatus 1 according to this embodiment are explained above. Next, an overall operation of the miRNA detecting apparatus 1 will be explained. Base sequence information of a detection processing target is inputted from the input unit 3 to the miRNA detecting apparatus 1. Sequence information may be read from the recording medium or may be acquired from the network by communication. The base sequence information may be, for example, text data of a base sequence. The base sequence information is converted into base vector sequence data by the base-vector-sequence generating unit 5. The miRNA detecting unit 9 detects miRNA regions using the base vector sequence data generated by the base-vector-sequence generating unit 5 and the models stored in the miRNA-model storing unit 7. The miRNA detecting unit 9 detects, based on the HMM and the Viterbi algorithm, a region matching the miRNA model and not matching the non-miRNA models on the sequence as a miRNA region. Information concerning the detected miRNA regions is outputted from the output unit 11. For example, information concerning miRNA may be displayed on the display, outputted to the printer, written in the recording medium, or outputted to the outside by communication.

The base sequence of the detection processing target is, for example, the human genome. When the miRNA detecting apparatus 1 according to this embodiment is used, new miRNAs can be suitably detected from the human genome comprehensively.

The miRNA detecting apparatus 1 according to this embodiment is explained above. As described above, in the present invention, the base vector sequence data generated from the base sequence information of the detection processing target and the microRNA model that is the probability model of the known microRNAs are used. In the present invention, a microRNA region can be detected by finding a region matching the microRNA model from the base sequence. In the present invention, each of the base vectors making up the base vector sequence data includes the parameter of a degree of evolutional conservation and the parameters of the stable hairpin structure, which is the characteristic of microRNA. In particular, concerning the stable hairpin structure, each of the base vectors includes the parameters representing possibilities that each of the bases correspond to the stem and the loop based on a base pair probability, in addition to the parameter of minimum free energy. By adopting such vector representation, the accuracy or performance of detection of microRNA can be improved.

The advantages of the present invention will be further explained. In the conventional microRNA detection technique, as already explained, the pipeline that combines homology search and secondary structure prediction step by step is proposed. At a plurality of steps in the pipeline, arbitrary thresholds and the like can be set at the respective steps, affecting the detection result. On the other hand, in the present invention, microRNA is predicted without employing the pipeline structure having two steps. In the present invention, microRNA is predicted from the model that employs the base vectors having the parameters of both the conservation degree and the secondary structure. More specifically, likelihood is used as one index. Therefore, it is possible to perform more objective assessment than the conventional technique such as the pipeline. Moreover, as described above, the base vectors include the parameters representing possibility of the stem and the loop, in addition to the conservation score parameter and the energy parameter indicating secondary structure stability. The vector representation used in the present invention accurately represents features of microRNA by including these parameters together Thus, according to the present invention, microRNA can be detected at high prediction accuracy.

In the present invention, the microRNA model may be the Hidden Markov Model. The microRNA detecting unit may be configured to perform variable-length microRNA region detection using the Hidden Markov Model. By using the Hidden Markov Model, the microRNA region can be detected without fixing sequence length. Therefore, when a sequence such as a genome or the like is inputted, microRNAs having various lengths can be suitably detected.

The microRNA model may be generated from a group of known microRNAs having unfixed sequence length. By using the Hidden Markov Model, the microRNA model can be suitably created even if the sequence lengths of the known microRNAs are not constant or fixed.

The Hidden Markoy Model of the microRNA model may be a state transition model in which respective states correspond to respective bases of a base sequence. The number of states through which a state transition path can pass may be limited to a predetermined range. Consequently, microRNA can be suitably detected using the Hidden Markov Model as described above. By limiting the number of transition states to the predetermined range, the length of detected microRNA can be limited to an appropriate range, thereby improving the accuracy of detection.

The Hidden Markov Model of the microRNA model may be a state transition model in which respective states correspond to respective bases of a base sequence. State transition probabilities of respective sections of the model may be set such that a product of state transition probabilities along a state transition path is the same regardless of the state transition path. By setting the state transition probabilities in this way, it is possible to appropriately control the influence of sequence length on miRNA detection and suitably perform variable-length microRNA detection.

The loop parameter may include a base pair probability total, which is a total of base pair probabilities corresponding to base pairs sequentially located on outer sides with respect to the relevant base as the center, based on a base pair probability matrix. Consequently, making use of a characteristic of a loop section that the loop section is sandwiched from both sides by stem sections that form base pairs, the parameter can be calculated so as to appropriately represent a possibility that each of the bases correspond to the loop section, thereby making it possible to improve the accuracy of detection of microRNA.

The base pair probability total of the loop parameter may include a total of base pair probabilities corresponding to base pairs sequentially located on outer sides when, assuming that the number of bases in the loop section is an even number, the relevant base and a base next to the relevant base are set as a first base pair. Consequently, the loop parameter can be calculated taking into account a case in which the number of bases of the loop section is an even number, and therefore the accuracy of detection of microRNA is improved.

The loop parameter may be a weighted average of a plurality of base pair probability totals respectively corresponding to a plurality of bases in a predetermined range around the relevant base. Consequently, the loop parameter can be calculated taking into account a bulge in the stem section as well, and therefore the accuracy of detection of microRNA can be improved.

The microRNA-model storing unit may further store a non-microRNA model, which is a probability model generated from a non-microRNA group known as not corresponding to microRNA. The microRNA detecting unit may detect a region matching the microRNA model and not matching the non-microRNA model as a microRNA region. Consequently, the accuracy of detection of microRNA can be improved by using the non-microRNA model together with the microRNA model. When the Hidden Markov Model is used, the microRNA model and the non-microRNA model may be connected such that states can be transitioned and regions matching the microRNA model may be detected.

According to the present invention, the microRNA-model storing unit may store a plurality of the non-microRNA models respectively generated from a plurality of non-microRNA groups having different degrees of evolutional conservation. Consequently, the accuracy of detection can be improved by preparing the non-microRNA model taking into account the degrees of evolutional conservation. In this regard, if sequences of non-microRNA are simply collected, sequences with low conservation degrees occupy most of the collected sequence group. It is assumed that the non-microRNA model is created from such a sequence group with low conservation degrees, and the non-microRNA model is used together with the microRNA model. In that case, contribution of the degrees of evolutional conservation in prediction of microRNA is large and contribution of an index of the stable hairpin structure is low. Such a situation can be prevented according to the present invention. Both the degrees of evolutional conservation and the stability of the hairpin structure can be suitably assessed to highly accurately detect microRNA.

The stem parameters may include a parameter representing a probability that the relevant base is located In the stem section on the 5′ side and a parameter representing a probability that the relevant base is located in the stem section on the 3′ side. Consequently, microRNA can be detected taking into account a case in which the each of bases are located in the stem section on both sides of the hairpin structure, and the accuracy of detection can be improved.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. A microRNA detecting apparatus that detects a microRNA region from base sequence information, the microRNA detecting apparatus comprising:
an input unit that inputs base sequence information of a detection processing target;
a base-vector-sequence generating unit that generates, from the base sequence information of the detection processing target, base vector sequence data formed by a plurality of base vectors respectively corresponding to a plurality of bases included in a sequence, each of the base vectors including a plurality of kinds of parameters that characterize microRNA:
a microRNA-model storing unit that stores a microRNA model that is generated from a known microRNA group, the microRNA model being a probability model of a base vector sequence group and including a plurality of the base vector sequence data respectively corresponding to a plurality of known microRNAs in the known microRNA group; and
a microRNA detecting unit that detects, based on the base vector sequence data generated by the base-vector-sequence generating unit and the microRNA model of the microRNA-model storing unit, a region matching the microRNA model from the base sequence of the detection processing target as a microRNA region, wherein
the plurality of kinds of parameters of each of the base vectors forming the base vector sequence data include a conservation score parameter representing a degree of evolutional conservation in a relevant base of each of the base vectors, and secondary structural parameters characterizing a stable hairpin structure, and
the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.

2. The microRNA detecting apparatus according to claim 1, wherein
the microRNA model is a Hidden Markov Model, and
the microRNA detecting unit performs variable-length microRNA region detection using the Hidden Markov Model.

3. The microRNA detecting apparatus according to claim 2, wherein the microRNA model is generated from a group of known microRNAs with unfixed sequence length.

4. The microRNA detecting apparatus according to claim 2, wherein
the Hidden Markov Model of the microRNA model is a state transition model in which respective states correspond to respective bases of a base sequence, and
a number of states through which a state transition path can pass is limited to a predetermined range.

5. The microRNA detecting apparatus according to claim 2, wherein
the Hidden Markov Model of the microRNA model is a state transition model in which respective states correspond to respective bases of a base sequence, and
state transition probabilities of respective sections of the model are set such that a product of state transition probabilities along a state transition path is the same regardless of the state transition path.

6. The microRNA detecting apparatus according to claim 1, wherein the loop parameter includes a base pair probability total, which is a total of base pair probabilities corresponding to base pairs sequentially located on outer sides with respect to the relevant base as the center, based on a base pair probability matrix.

7. The microRNA detecting apparatus according to claim 6, wherein the base pair probability total of the loop parameter includes a total of base pair probabilities corresponding to base pairs sequentially located on outer sides when, assuming that the number of bases in the loop section is an even number, the relevant base and a base next to the relevant base are set as a first base pair.

8. The microRNA detecting apparatus according to claim 6, wherein the loop parameter is a weighted average of a plurality of the base pair probability totals respectively corresponding to a plurality of bases in a predetermined range around the relevant base.

9. The microRNA detecting apparatus according to claim 1, wherein
the microRNA-model storing unit further stores a non-microRNA model, which is a probability model generated from a non-microRNA group known as not corresponding to microRNA, and
the microRNA detecting unit detects a region matching the microRNA model and not matching the non-microRNA model as the microRNA region.

10. The microRNA detecting apparatus according to claim 9, wherein the microRNA-model storing unit stores a plurality of the non-microRNA models respectively generated from a plurality of non-microRNA groups having different degrees of evolutional conservation.

11. The microRNA detecting apparatus according to claim 1, wherein the stem parameter includes a parameter representing a probability that the relevant base is located in the stem section on a 5′ side and a parameter representing a probability that the relevant base is located in the stem section on a 3′ side.

12. A microRNA detecting method of detecting a microRNA region by processing base sequence information with a computer, the microRNA detecting method comprising performing processing for:
inputting base sequence information of a detection processing target;
generating, from the base sequence information of the detection processing target, base vector sequence data formed by a plurality of base vectors respectively corresponding to a plurality of bases included in a sequence, each of the base vectors including a plurality of kinds of parameters that characterize microRNA; and
detecting, using a microRNA model that is a probability model of a base vector sequence group including a plurality of the base vector sequence data respectively corresponding to a plurality of known microRNAs in a known microRNA group, a region matching the microRNA model from the base sequence of the detection processing target as a microRNA region, wherein
the plurality of kinds of parameters of each of the base vectors forming the base vector sequence data include a conservation score parameter representing a degree of evolutional conservation in a relevant base of each of the base vectors, and secondary structural parameters characterizing a stable hairpin structure, and
the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.

13. A microRNA detecting program for causing a computer to execute microRNA detection processing for detecting a microRNA region from base sequence information, the microRNA detecting program causing the computer to execute processing for;
generating, from inputted base sequence Information of a detection processing target, base vector sequence data formed by a plurality of base vectors respectively corresponding to a plurality of bases included in a sequence, each of the base vectors including a plurality of kinds of parameters that characterize microRNA; and
detecting, using a microRNA model that is a probability model of a base vector sequence group including a plurality of the base vector sequence data respectively corresponding to a plurality of known microRNAs in a known microRNA group, a region matching the microRNA model from the base sequence of the detection processing target as a microRNA region, wherein
the plurality of kinds of parameters of each of the base vectors forming the base vector sequence data include a conservation score parameter representing a degree of evolutional conservation in a relevant base of each of the base vectors, and secondary structural parameters characterizing a stable hairpin structure, and
the secondary structural parameters include an energy parameter representing minimum free energy in surrounding regions of the relevant base, a stem parameter representing, based on a base pair probability that is a probability that two bases in a base sequence form a base pair, a level of possibility that the relevant base is located in a stem section of the hairpin structure, and a loop parameter representing, based on the base pair probability, a level of possibility that the relevant base is located in a loop section of the hairpin structure.
